(19) United States
(12) Patent Application Publication
(10) Pub. No.: US 2017/0115866 A1
(43) Pub. Date: Apr. 27, 2017

(54) METHOD, DEVICE AND TERMINAL APPARATUS FOR RECOGNIZING MULTI-FINGER SLIDING GESTURE

(71) Applicant: Leauto Intelligent Technology (BEIJING) Co. Ltd., Chaoyang District Beijing (CN)

(72) Inventors: Yang JIANG, Beijing (CN); LuLu ZHOU, Beijing (CN)

(73) Assignee: Leauto Intelligent Technology (BEIJING) Co. Ltd., Chaoyang District Beijing (CN)

(21) Appl. No.: 14/973,699

(22) Filed: Dec. 17, 2015

(30) Foreign Application Priority Data
Oct. 23, 2015 (CN) 201510698229.1

(51) Int. Cl. G06F 3/0488; G06F 3/041

(52) U.S. Cl. CPC G06F 3/04883; G06F 3/0416; G06F 2203/04808; G06F 2203/04104

(57) ABSTRACT

The present disclosure provides a method, a device, and a terminal apparatus for recognizing a multi-finger sliding gesture. The method includes detecting a plurality of touch events on a touch screen by a user, and acquiring touch event data corresponding to each of the touch events, the touch event data including coordinates of a plurality of touch points and the time of the touch event; calculating an average sliding rate of each of the touch points based on the touch event data; determining that the user's gesture is a multi-finger sliding gesture, if the average sliding rate of each of the touch points is greater than or equal to a preset sliding rate. The method, device, and terminal apparatus for recognizing a multi-finger sliding gesture of embodiment of the present disclosure may implement recognizing of multi-finger sliding gestures so as to meet the needs of the users.

### CROSS-REFERENCE TO RELATED APPLICATIONS

This application claims priority to Chinese Patent Application No. 201510698229.1, with the title of “ [symbol] , [symbol] ” (Device, Method, and Terminal Apparatus for Recognizing a Multi-Finger Sliding Gesture), filed on Oct. 23, 2015, which is hereby incorporated by reference in its entirety.

### TECHNICAL FIELD

The present disclosure relates to a field of terminal technology, and more particularly to a method, device, and terminal apparatus for recognizing a multi-finger sliding gesture.

### BACKGROUND

Right now, touch screen is widely used for various kinds of terminal apparatus (for example, mobile phone, tablet, navigator), and the general gestures applied to touch screen terminal apparatuses are the main medium for implementing human-computer interaction. For example, the single click gesture is used for opening or closing application programs, long pressing gesture is used for dragging some icon, and sliding gesture is used for unlocking apparatus, finding contacts, and so on.

As the diversification of the functions of touch screen terminal apparatus and the application environment, the current general gestures cannot meet the needs of users. For example, in a vehicle-machine environment, the driver may feel difficult and unsafe in operations such as closing frequently operated applications such as voicing by making single click on a small icon during driving, and therefore, it is possible to call out applications by gestures of multi-finger sliding or the like. However, the current touch screen terminal apparatuses support multi-point touch, but do not provide a recognizing solution with respect to multi-finger sliding gestures.

### SUMMARY

The embodiments of the present disclosure provide a method, a device, and a terminal apparatus for recognizing a multi-finger sliding gesture, which may implement recognizing of multi-finger sliding gestures so as to meet the needs of the users.

To achieve the above technical objects, the embodiments of the present disclosure provide the following technical solutions.

In the first aspect, the embodiment of the present disclosure provides a method for recognizing a multi-finger sliding gesture including: detecting a plurality of touch events on a touch screen by a user, and acquiring touch event data corresponding to each of the touch events, the touch event data including coordinates of a plurality of touch points and the time of the touch event; calculating an average sliding rate of each of the touch points based on the touch event data; and determining that the user's gesture is a multi-finger sliding gesture, if the average sliding rate of each of the touch points is greater than or equal to a preset sliding rate.

In the second aspect, the embodiment of the present disclosure provides a device for recognizing a multi-finger sliding gesture including a detecting module configured to detect a plurality of touch events on a touch screen by a user, and acquire a touch event data corresponding to each of the touch events, the touch event data including coordinates of a plurality of touch points and the time of the touch event; a calculating module configured to calculate an average sliding rate of each of the touch points based on the touch event data; and a determining module configured to determine that the user's gesture is a multi-finger sliding gesture, if the average sliding rate of each of the touch points is greater than or equal to a preset sliding rate.

In the third aspect, the embodiment of the present disclosure provides a device for recognizing s multi-finger sliding gesture including: one or more processors; a memory; and one or more programs stored in the memory and configured to perform operations when executed by the one or more processors, wherein the operations comprises: detecting a plurality of touch events on a touch screen by a user, and acquiring touch event data corresponding to each of the touch events, the touch event data comprising coordinates of a plurality of touch points and the time of the touch event; calculating an average sliding rate of each of the touch points based on the touch event data; and determining that the user's gesture is a multi-finger sliding gesture, if the average sliding rate of each of the touch points is greater than or equal to a preset sliding rate.

In the fourth aspect, the embodiment of the present disclosure provides a terminal apparatus including the device for recognizing a multi-finger sliding gesture as described above.

The method, device, and terminal apparatus for recognizing a multi-finger sliding gesture provided by the present disclosure may implement recognizing of multi-finger sliding gestures so as to meet the needs of the users by detecting a plurality of touch events on a touch screen by a user, and calculating an average sliding rate of each of the touch points and a value of reduced or increased distance between any two touch points based on acquired touch event data corresponding to each of the touch events; determining that the user's gesture is a multi-finger sliding gesture, if the average sliding rate of each of the touch points is greater than or equal to a preset sliding rate.

### BRIEF DESCRIPTION OF THE DRAWINGS

FIG. 1 is a flowchart illustrating an embodiment of a method for recognizing a multi-finger sliding gesture provided by the present disclosure;

FIG. 2 is a flowchart illustrating another embodiment of a method for recognizing a multi-finger sliding gesture provided by the present disclosure;

FIG. 3 is a schematic diagram of storing touch event data upon happening of a first touch event;

FIG. 4 is a schematic diagram of storing touch event data upon happening of a second touch event;

FIG. 5 is a schematic diagram of storing touch event data upon happening of a seventh touch event;

FIG. 6 is a structural diagram of an embodiment of the device for recognizing a multi-finger sliding gesture provided by the present disclosure;

FIG. 7 is a structural diagram of another embodiment of the device for recognizing a multi-finger sliding gesture provided by the present disclosure;

FIG. 8 is a structural diagram of another embodiment of the device for recognizing a multi-finger sliding gesture provided by the present disclosure; and

FIG. 9 is a structural diagram of an embodiment of the terminal apparatus provided by the present disclosure.

### DESCRIPTION OF THE EMBODIMENTS

In the following, description will be given in detail on the method, device, and terminal apparatus for recognizing a multi-finger sliding gesture provided by the present disclosure, in connection with the accompanying drawing.

### First Embodiment

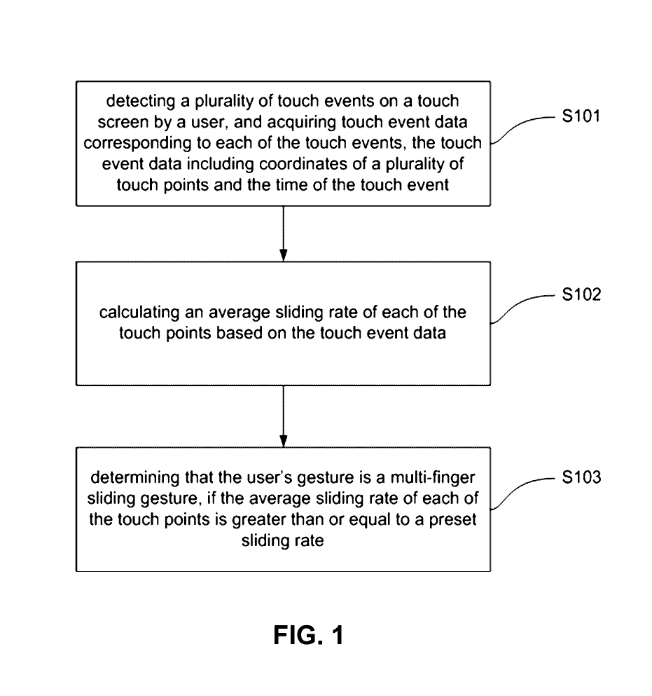

FIG. 1 is a flowchart illustrating an embodiment of the method for recognizing a multi-finger sliding gesture provided by the present disclosure. The method for recognizing a multi-finger sliding gesture of the embodiment of the present disclosure may be applicable to various kinds of touch screen terminal apparatus (for example, mobile phone, tablet, and navigator). As shown in FIG. 1, the method for recognizing a multi-finger sliding gesture of the embodiment of the present disclosure includes:

S101: detecting a plurality of touch events on a touch screen by a user, and acquiring touch event data corresponding to each of the touch events, the touch event data including coordinates of a plurality of touch points and the time of the touch event.

More particularly, when the user performs multi-finger sliding (for example, three-finger sliding), the terminal apparatus may detect the occurrence of touch event according to the sliding track on the touch screen made by the user, periodically acquire touch event data corresponding to each of the touch events (including coordinates of a plurality of touch points and the time of the touch event). According to the experiments, in a general procedure of multi-finger sliding, a terminal apparatus may detect occurrences of 7-15 touch events, which correspond to 7-15 groups of touch event data. The coordinates of a plurality of touch points may be X-axis coordinates corresponding to the left-right sliding on the touch screen, Y-axis coordinate corresponding to the up-down sliding on the touch screen, or the like.

S102: calculating an average sliding rate of each of the touch points based on the touch event data.

More particularly, for example, an average sliding rate of a touch point may be calculated by dividing the difference of coordinates of the touch point in two touch events by the difference of the time of the two touch events. The average sliding rates of other touch points may be calculated with similar methods.

S103: determining that the user's gesture is a multi-finger sliding gesture, if the average sliding rate of each of the touch points is greater than or equal to a preset sliding rate.

More particularly, according to experiments, in a general procedure of multi-finger sliding, an average sliding rate is about 1.7 pixel/millisecond; therefore a preset sliding rate may be set as 1.7 pixel/millisecond. It is apparent to one skilled in the art that the preset sliding rate may be set as other value in a range of 1.5-2.0 pixel/millisecond. It can be determined that an event of multi-finger sliding occurs, that is, the user's gesture is a multi-finger sliding gesture, if the average sliding rates of a plurality of touch points are all greater than or equal to a preset sliding rate.

The method for recognizing a multi-finger sliding gesture of the present disclosure may implement recognizing of multi-finger sliding gestures so as to meet the needs of the users by detecting a plurality of touch events on a touch screen by a user, and calculating an average sliding rate of each of the touch points based on acquired touch event data corresponding to each of the touch events; determining that the user's gesture is a multi-finger sliding gesture, if the average sliding rate of each of the touch points is greater than or equal to a preset sliding rate.

### Second Embodiment

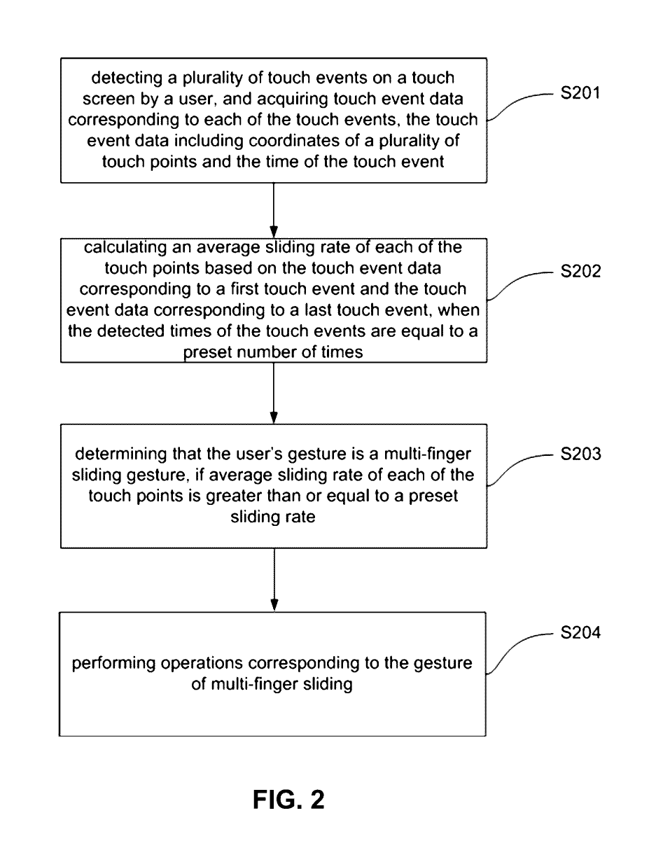

FIG. 2 is a flowchart illustrating another embodiment of the method for recognizing a multi-finger sliding gesture provided by the present disclosure. The method for recognizing a multi-finger sliding gesture of the embodiment of the present disclosure may be applicable to various kinds of touch screen terminal apparatus (for example, mobile phone, tablet, and navigator). As shown in FIG. 2, the method for recognizing a multi-finger sliding gesture of the embodiment of the present disclosure is another feasible implementation of the method for recognizing a multi-finger sliding gesture as shown in FIG. 1, and particularly includes:

S201: detecting a plurality of touch events on a touch screen by a user, and acquiring touch event data corresponding to each of the touch events, the touch event data including coordinates of a plurality of touch points and the time of the touch event.

More particularly, the description of detailed procedure of the step S201 can refer to the description of Step S101 in the embodiment shown in FIG. 1, and thus may be omitted to avoid redundancy.

S202: calculating an average sliding rate of each of the touch points based on the touch event data corresponding to a first touch event and the touch event data corresponding to a last touch event, when the detected times of the touch events are equal to a preset number of times.

More particularly, according to the experiments, in a general procedure of multi-finger sliding, a terminal apparatus may detect occurrences of 7-15 touch events and thus the preset number of times may be set as 7. It is apparent that the preset number of times may also be set as other value in a range of 7-15. It should be noted that the preset number of times should not be set too small so as to avoid misjudgment due to sliding over short distance. When the detected times of touch events are equal to the preset number of times, such as 7, the average sliding rate of some touch point may be calculated by dividing the difference of coordinates of this touch point in the first touch event and the seventh touch event by the difference of time of these two touch events. The average sliding rate of other touch points may be calculated by similar method.

S203: determining that the user's gesture is a multi-finger sliding gesture, if average sliding rate of each of the touch points is greater than or equal to a preset sliding rate.

More particularly, the description of detailed procedure of the step S203 is similar with the description of Step S103 in the embodiment shown in FIG. 1, and thus may be omitted to avoid redundancy.

Furthermore, after the step S203, the method for recognizing a multi-finger sliding gesture of the embodiment of the present disclosure may further include:

S204: performing operations corresponding to the gesture of multi-finger sliding.

More particularly, if it is determined that the user's current gesture is a multi-finger sliding gesture, an operation corresponding to the gesture of multi-finger sliding, such as launching application, may be performed so as to meet the user's needs.

Furthermore, before the step S202, the method for recognizing a multi-finger sliding gesture of the embodiment of the present disclosure may further include: storing the touch event data in array sequentially in order, wherein the length of the array may be equal to the preset number of times.

More particularly, array is a set in which elements in the same data type is arranged in certain order, so as to store data. The terminal apparatus may package the touch event data into a Finger X Y Data Box object to be stored in array. The length of the array may not be too long; and otherwise the time-space complexity for running program may be increased. The length of array may be defined as 7.

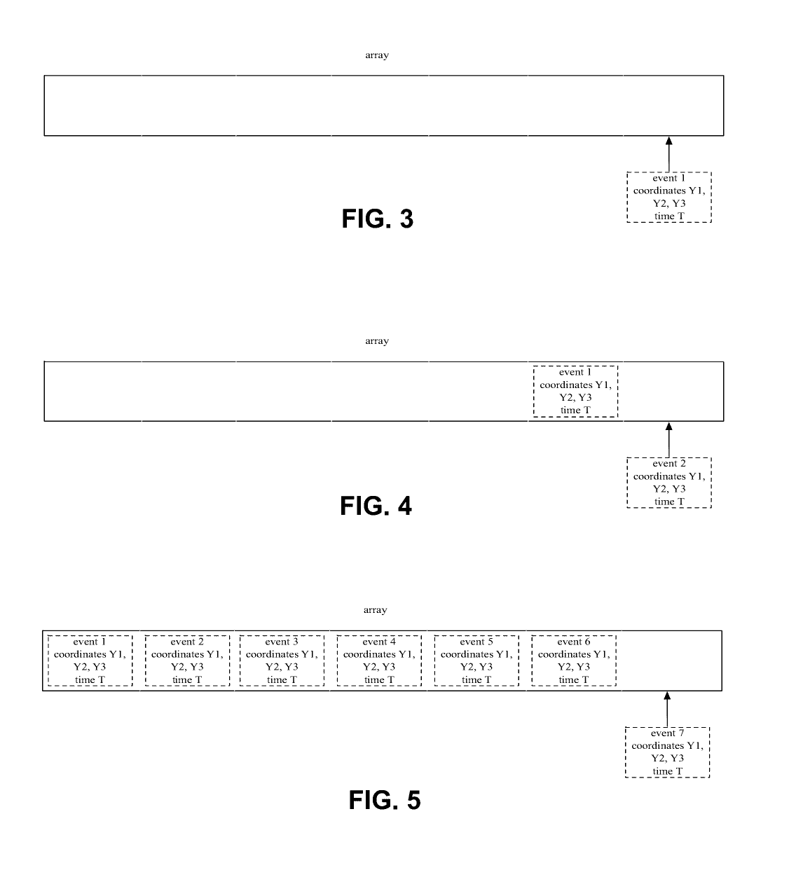

Assuming that the length of array is 7 and three fingers are sliding as an example, the dynamic flow of the touch event data when being stored in the array is shown in FIG. 3-FIG. 5. More particularly, FIG. 3 is a schematic diagram of storing touch event data upon happening of the first touch event, FIG. 4 is a schematic diagram of storing touch event data upon happening of the second touch event, and FIG. 5 is a schematic diagram of storing touch event data upon happening of the seventh touch event. As shown in FIG. 3-FIG. 5, when the first touch event (event 1) occurs, the corresponding touch event data (Y-axis coordinates of three touch points: Y1, Y2, Y3, and the time of the first touch event: T) may be stored in the array as the seventh element; when the second touch event (event 2) occurs, the touch event data corresponding to the first touch event is left-shifted as the sixth element in the array, the touch event data corresponding to the second touch event (Y-axis coordinates of three touch points: Y1, Y2, Y3, and the time of the second touch event: T) may be stored in the array as the seventh element; being continued likewise, when the seventh touch event (event 7) occurs, the touch event data corresponding to the first touch event is left-shifted as the first element in the array, the touch event data corresponding to the seventh touch event (Y-axis coordinates of three touch points: Y1, Y2, Y3, and the time of the seventh touch event: T) may be stored in the array as the seventh element, and then the array is full for storage.

Furthermore, step S202 may particularly include: calculating an average sliding rate of each of the touch points based on the touch event data corresponding to a first touch event and the touch event data corresponding to a last touch event, when the array is full for storage.

More particularly, when the array is not full for storage, that is, the first element in the array is null, the calculation may not be performed, so as to avoid the misjudgment due to sliding over too short distance.

Furthermore, after the step S203, the method for recognizing a multi-finger sliding gesture of the embodiment of the present disclosure may further include: emptying the array to avoid determining the occurrence of multi-finger sliding multi-times in single multi-finger sliding event. It is unnecessary to clear the array after a complete multi-finger sliding event. When there is new touch event data inserted into the array, the condition for determining multi-finger sliding would not be met immediately upon touching, since the time interval would be large.

The method for recognizing a multi-finger sliding gesture of the embodiment of the present disclosure may be implemented based on the touch event call back frame and broadcasting mechanism of Android system. In the system after Android 5.0, all touch events may be distributed to foreground applications in the DiagramRootImpl.java class, the current touch event may be obtained in DiagramRootImpl.java, and the Android system uses MotionEvent.java class to describe the touch event.

More particularly, the variables obtainable by the Android system are as follows: 1. notice event MotionEvent.ACTION MOVE may be obtained upon single-finger or multi-finger sliding; 2. the total number of touch points on the current screen may be obtained by MotionEvent.GetPointerCount( ) 3. the X-axis coordinate and Y-axis coordinate of the “i”th touch point by MotionEvent.Get X(i), MotionEvent.GetY(i).

More particularly, the touch variables obtained in experiments are as follows: 1. in a general procedure of multi-finger sliding, the system may return 7-15 touch events; and 2. in a general procedure of multi-finger sliding, the average sliding rate is about 1.7 pixel/millisecond (based on Gaxlaxy Note 8.0 tablet from Samsung).

The related Java codes are described as follows:

1. a class for storing the transient touching information private class FingerYDataBox

{

// storing Y-axis coordinates of each points
float yData[ ];
long time;
public FingerYDataBox(float[ ] yData, long time) {

this.yData = yData;
this.time = time;

}
}

2. a function for determining an average rate over a period private booleanisMatchVelocity(float oldY, float newY,

float thresholdVelocity, inttimeElapsing) {

return ((old Y − new Y) /time Elapsing)>= thresholdVelocity;
}

3. a function for emptying the elements in an array private void clearDataBox(FingerYDataBox[]boxes) {

for (inti = 0; i<boxes.length; i++) {
boxes[i] = null;

}
}

4. a function for determining whether or not it is a multi-finger sliding event private booleanisMatchVelocityForMultiFingers(FingerYData

Box[ ] dataBoxes, FingerYDataBoxcurrentBox,

float thresholdVelocity) {

```
  // shifting the elements in an array to the left
System.arraycopy(dataBoxes, 1, dataBoxes, 0, dataBoxes.length − 1);
  // inserting a new event to the end of an array
```

DataBoxes[dataBoxes.length − 1] = currentBox;

// no comparing if the first element in an array is null

if (dataBoxes[0] == null)

return false;

```
  int time Elapsing=(int) (currentBox.time − dataBoxes[0].time);
  boolean result = true;
```

// determining it is a multi-finger sliding only if the average rates of

all touch points meet the requirement
for(inti = 0; i<dataBoxes[0].yData.length; i++) {

result = result

&&isMatchVelocity(dataBoxes[0].

yData[i], currentBox.yData[i],

thresholdVelocity, timeElapsing);

}
return result;

}

5. the constants are defined as follows

```
  // threshold for rate
private static final float THRESHOLD_VELOCITY = 1.7f;
  // number of touch events stored for least sliding
private static final int THRESHOLD_SAVED_POINT_COUNT = 7;
private static final int THREE_FINGER_TOUCH = 3;
private static final int FOUR_FINGER_TOUCH = 4;
private static final int FIVE_FINGER_TOUCH = 5;
private FingerYDataBox[ ] mThreeDataBoxes = new
FingerYDataBox[THRESHOLD_SAVED_POINT_COUNT];
private FingerYDataBox[ ] mFourDataBoxes = new
FingerYDataBox[THRESHOLD_SAVED_POINT_COUNT];
private FingerYDataBox[ ] mFiveDataBoxes = new
FingerYDataBox[THRESHOLD_SAVED_POINT_COUNT];
```

6. codes for determining whether or not it is a multi-finger sliding public booleanmultiFingersFlingTriggered()

{

```
  int count = getPointerCount( );
  if (THREE_FINGER_TOUCH == count) {
```

if (isMatchVelocityForMultiFingers(mThreeDataBoxes , new

FingerYDataBox(new float[ ] {

getY(0) , get Y(1) , get Y(2)} , getEventTime( )) ,

THRESHOLD_VELOCITY)) {

// clear data after meeting requirement, to avoid meeting the

requirement in a row
ClearDataBox(mThreeDataBoxes);

return true;

}

} else if (FOUR_FINGER_TOUCH == count) {

if (isMatchVelocityForMultiFingers(mFourDataBoxes , new

FingerYDataBox(new float[ ] {
getY(0), getY(1), getY(2), getY(3)},

getEventTime( )),

THRESHOLD_VELOCITY)) {

clearDataBox(mThreeDataBoxes);

return true;

}

} else if (FIVE_FINGER_TOUCH == count) {

if (isMatchVelocityForMultiFingers(mFiveDataBoxes , new

FingerYDataBox(new float[ ] {

getY(0), getY(1), getY(2), getY(3),

get Y(4)}, getEventTime( )),
THRESHOLD_VELOCITY)) {

clearDataBox(mThreeDataBoxes);

return true;

}

}
return false;

}

The method for recognizing a multi-finger sliding gesture of the present disclosure may implement recognizing of multi-finger sliding gestures so as to meet the needs of the users by detecting a plurality of touch events on a touch screen by a user, and calculating an average sliding rate of each of the touch points based on acquired touch event data corresponding to each of the touch events; determining that the user's gesture is a multi-finger sliding gesture, if the average sliding rate of each of the touch points is greater than or equal to a preset sliding rate.

### Third Embodiment

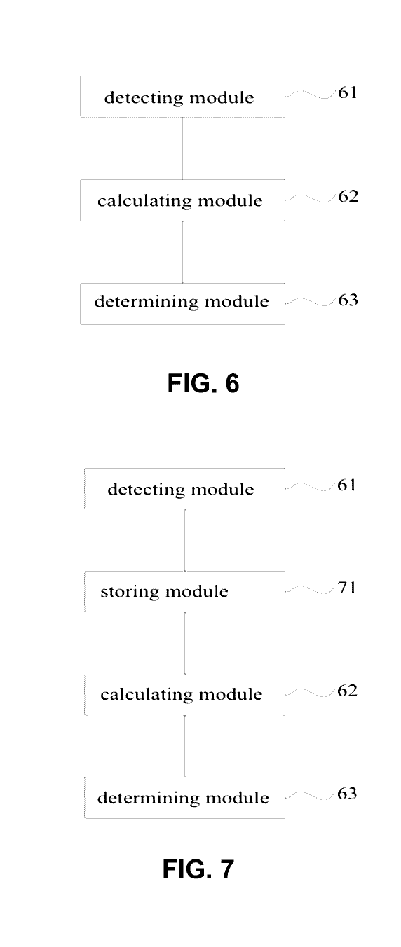

FIG. 6 is a structural diagram of an embodiment of the device for recognizing a multi-finger sliding gesture provided by the present disclosure. The device for recognizing a multi-finger sliding gesture of the embodiment of the present disclosure may be installed in various kinds of touch screen terminal apparatus (for example, mobile phone, tablet, navigator) to implement the method for recognizing a multi-finger sliding gesture of the embodiment as shown in FIG. 1. As shown in FIG. 6, the device for recognizing a multi-finger sliding gesture provided by the present disclosure may include: a detecting module 61, a calculation module 62, and a determining module 63.

The detecting module 61 is configured to detect a plurality of touch events on a touch screen by a user, and acquires touch event data corresponding to each of the touch events, the touch event data including coordinates of a plurality of touch points and the time of the touch event.

The calculating module 62 is configured to calculate an average sliding rate of each of the touch points based on the touch event data.

The determining module 63 is configured to determine that the user's gesture is a multi-finger sliding gesture, if the average sliding rate of each of the touch points is greater than or equal to a preset sliding rate.

More particularly, the description of procedures for respective modules of the device for recognizing a multi-finger sliding gesture provided by the embodiment of the present disclosure to implement their functions may refer to the description in the embodiment of the method shown in FIG. 1, and thus may be omitted to avoid redundancy.

The device for recognizing a multi-finger sliding gesture of the present disclosure may implement recognizing of multi-finger sliding gestures so as to meet the needs of the users by detecting a plurality of touch events on a touch screen by a user, and calculating an average sliding rate of each of the touch points based on acquired touch event data corresponding to each of the touch events; determining that the user's gesture is a multi-finger sliding gesture, if the average sliding rate of each of the touch points is greater than or equal to a preset sliding rate.

### Fourth Embodiment

FIG. 7 is a structural diagram of another embodiment of the device for recognizing a multi-finger sliding gesture provided by the present disclosure. The device for recognizing a multi-finger sliding gesture of the embodiment of the present disclosure may be installed in various kinds of touch screen terminal apparatus (for example, mobile phone, tablet, navigator) to implement the method for recognizing a multi-finger sliding gesture of the embodiment as shown in FIG. 2. As shown in FIG. 7, based on the embodiment shown in FIG. 6, the calculating module 62 of the device for recognizing a multi-finger sliding gesture provided by the present disclosure may be further configured to: calculate an average sliding rate of each of the touch points based on the touch event data corresponding to a first touch event and the touch event data corresponding to a last touch event, when the detected times of the touch events are equal to a preset number of times.

More particularly, the device for recognizing a multi-finger sliding gesture provided by the present disclosure may further include a storing module 71 configured to store the touch event data in array sequentially in order, wherein the length of the array may be equal to the preset number of times.

More particularly, the calculating module 62 may be configured to calculate an average sliding rate of each of the touch points based on the touch event data corresponding to a first touch event and the touch event data corresponding to a last touch event, when the array is full for storage.

More particularly, the determining module 62 may be further configured to clear the array when it is determined that the user's gesture is a multi-finger sliding gesture.

More particularly, the average sliding rate may be set as 1.7 pixel/millisecond, the coordinates may include X-axis coordinate or Y-axis coordinate, and the preset number of times may be 7.

Furthermore, the determining module 63 may be further configured to perform operations corresponding to the gesture of multi-finger sliding when it is determined that the user's gesture is a multi-finger sliding gesture.

More particularly, the description of procedures for respective modules of the device for recognizing a multi-finger sliding gesture provided by the embodiment of the present disclosure to implement their functions may refer to the description in the embodiment of the method shown in FIG. 2, and thus may be omitted to avoid redundancy.

The device for recognizing a multi-finger sliding gesture of the present disclosure may implement recognizing of multi-finger sliding gestures so as to meet the needs of the users by detecting a plurality of touch events on a touch screen by a user, and calculating an average sliding rate of each of the touch points based on acquired touch event data corresponding to each of the touch events; determining that the user's gesture is a multi-finger sliding gesture, if the average sliding rate of each of the touch points is greater than or equal to a preset sliding rate.

### Fifth Embodiment

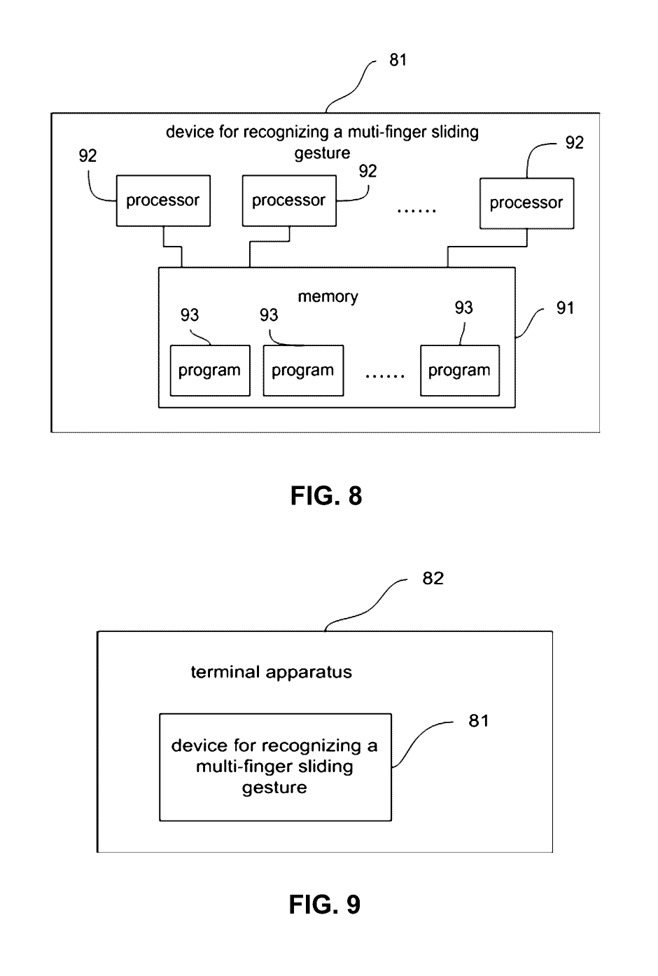

FIG. 9 is a structural diagram of an embodiment of the terminal apparatus provided by the present disclosure. The terminal apparatus of the embodiment of the present disclosure may be various kinds of touch screen terminal apparatus (for example, mobile phone, tablet, navigator) and may implement the method for recognizing a multi-finger sliding gesture of the embodiment as shown in FIG. 1 or FIG. 2. As shown in FIG. 9, the terminal apparatus 81 of the embodiment of the present disclosure may include the device for recognizing a multi-finger sliding gesture 82 of the embodiment as shown in FIG. 6, FIG. 7, or FIG. 8.

More particularly, the description of procedures for the device for recognizing a multi-finger sliding gesture 82 in the terminal apparatus 81 of the embodiment of the present disclosure to implement their functions may refer to the description in the embodiment of the method shown in FIG. 1 or FIG. 2, and thus may be omitted to avoid redundancy.

The terminal apparatus of embodiment of the present disclosure may implement recognizing of multi-finger sliding gestures so as to meet the needs of the users by detecting a plurality of touch events on a touch screen by a user, and calculating an average sliding rate of each of the touch points based on acquired touch event data corresponding to each of the touch events; and determining that the user's gesture is a multi-finger sliding gesture, if the average sliding rate of each of the touch points is greater than or equal to a preset sliding rate.

One skilled in the art would appreciate that all or a part of the steps for implementing the foregoing method embodiments may be implemented by hardware related to program instructions. Foregoing programs may be stored in computer-readable storage medium, and upon being executed, such programs may perform the steps including foregoing method embodiments; and examples of foregoing storage medium include ROM, RAM, CD-ROM, a magnetic tape, and the other types of storage mediums which may store the program codes.

It should be noted that the foregoing embodiments are merely used to illustrate the technical solution of the present disclosure, and not to limit the present disclosure. Although the present disclosure has been described in detail with reference to the foregoing embodiments, one skilled in the art would understand that the technical solutions recited in the foregoing embodiments may be modified or all or a part of the technical features may be replaced equally. These modifications and replacements are not intended to make corresponding technical solution depart from the scope of the technical solution of embodiments of the present disclosure.

What is claimed is:

1. A method for recognizing a multi-finger sliding gesture, comprising:
detecting a plurality of touch events on a touch screen by a user, and acquiring touch event data corresponding to each of the touch events, the touch event data comprising coordinates of a plurality of touch points and the time of the touch event;
calculating an average sliding rate of each of the touch points based on the touch event data; and
determining that the user's gesture is a multi-finger sliding gesture, if the average sliding rate of each of the touch points is greater than or equal to a preset sliding rate.

2. The method for recognizing a multi-finger sliding gesture according to claim 1, wherein the calculating an average sliding rate of each of the touch points based on the touch event data comprises:
calculating an average sliding rate of each of the touch points based on the touch event data corresponding to a first touch event and the touch event data corresponding to a last touch event, when the detected times of the touch events are equal to a preset number of times.

3. The method for recognizing a multi-finger sliding gesture according to claim 2, further comprising: storing the touch event data in an array sequentially in order, wherein the length of the array is equal to the preset number of times, and
the detected number of times of the touch events being equal to the preset number of times is the case that the array is full for storage.

4. The method for recognizing a multi-finger sliding gesture according to claim 3, wherein after the determining that the user's gesture is a multi-finger sliding gesture, the method further comprises:
emptying the array.

5. The method for recognizing a multi-finger sliding gesture according to claim 1, wherein after the determining that the user's gesture is a multi-finger sliding gesture, the method further comprises:
performing operations corresponding to the multi-finger sliding gesture.

6. A device for recognizing a multi-finger sliding gesture, comprising:
one or more processors;
a memory; and
one or more programs stored in the memory and configured to perform operations when executed by the one or more processors, wherein the operations comprises:
detecting a plurality of touch events on a touch screen by a user, and acquiring touch event data corresponding to each of the touch events, the touch event data comprising coordinates of a plurality of touch points and the time of the touch event;
calculating an average sliding rate of each of the touch points based on the touch event data; and
determining that the user's gesture is a multi-finger sliding gesture, if the average sliding rate of each of the touch points is greater than or equal to a preset sliding rate.

7. The device for recognizing a multi-finger sliding gesture according to claim 6, wherein the operation of calculating an average sliding rate of each of the touch points based on the touch event data comprises:
calculating an average sliding rate of each of the touch points based on the touch event data corresponding to a first touch event and the touch event data corresponding to a last touch event, when the detected times of the touch events are equal to a preset number of times.

8. The device for recognizing a multi-finger sliding gesture according to claim 7, wherein the operations further comprise:
storing the touch event data in an array sequentially in order, wherein the length of the array is equal to the preset number of times, and
the detected number of times of the touch events being equal to the preset number of times is the case that the array is full for storage.

9. The device for recognizing a multi-finger sliding gesture according to claim 8, wherein after the operation of determining that the user's gesture is a multi-finger sliding gesture, the operations further comprise:
emptying the array.

10. The device for recognizing a multi-finger sliding gesture according to claim 6, wherein after the operation of determining that the user's gesture is a multi-finger sliding gesture, the operations further comprise:
performing operations corresponding to the multi-finger sliding gesture.

11. A terminal apparatus comprising the device for recognizing a multi-finger sliding gesture according to claim 6.

12. A terminal apparatus comprising the device for recognizing a multi-finger sliding gesture according to claim 7.

13. A terminal apparatus comprising the device for recognizing a multi-finger sliding gesture according to claim 8.

14. A terminal apparatus comprising the device for recognizing a multi-finger sliding gesture according to claim 9.

15. A terminal apparatus comprising the device for recognizing a multi-finger sliding gesture according to claim 10.
